(19) United States
(12) Patent Application Publication
(10) Pub. No.: US 2024/0398656 A1
(43) Pub. Date: Dec. 5, 2024

(54) Non-Contact Induction Air Wave Massage Device

(71) Applicant: Mylovey Limited, Shenzhen (CN)

(72) Inventor: Huiming Zhong, Shenzhen (CN)

(73) Assignee: Mylovey Limited, Shenzhen (CN)

(21) Appl. No.: 18/407,694

(22) Filed: Jan. 9, 2024

Related U.S. Application Data
(63) Continuation-in-part of application No. 18/502,700, filed on Nov. 6, 2023.

(30) Foreign Application Priority Data
May 31, 2023 (CN) 202310639305.6

(51) Int. Cl. A61H 9/00

(52) U.S. Cl. CPC A61H 9/0071; A61H 9/0007

(57) ABSTRACT

A non-contact induction air wave massage device includes a rigid air wave cylinder defining an air wave chamber therein and having at least one opening communicating the air wave chamber with outside, and a magnetic air pressure valve member configured to be slidably disposed in the air wave chamber. A magnetic driving mechanism is arranged outside the air wave cylinder to generate a magnetic force to induce and drive the magnetic air pressure valve member to move back and forth reciprocately along a motion axis in the air wave chamber so as to change the air volume and air pressure between the magnetic air pressure valve member to produce air waves at the opening of the air wave chamber.

### CROSS REFERENCE OF RELATED APPLICATION

This application is a Continuation-In-Part application that claims the benefit of priority under 35U.S.C. § 120 to a non-provisional application, application Ser. No. 18/502,700, filed Nov. 6, 2023, which is a non-provisional application that claims the benefit of priority under 35U.S.C. § 119 to a Chinese application number CN202310639305.6, field May 31, 2023, which are incorporated herewith by references in their entireties.

### BACKGROUND OF THE PRESENT INVENTION

### Field of Invention

The present invention relates to a massage apparatus, and more particularly to a non-contact induction air wave massage device which produces air pressure wave without flexible chamber in a non-contact induction manner.

### Description of Related Arts

With the increasing pace of work and life, people are more liable to experience physical and mental fatigue. Manual massage or the use of therapeutic massage devices to massage specific body parts can greatly benefit by promoting blood circulation and relaxing muscles. It can also help to ease stress, relax the mind, and provide therapeutic and healthcare effects. To meet needs, several types of massage devices have emerged. However, most existing massage devices are directly driven, and often have poor waterproofing performance. Therefore, issues with the operation of the driving mechanism are caused frequently due to water-related problems.

Referring to FIG. 1, U.S. Pat. No. 6,733,438 discloses a female stimulation device (10) which comprises a resilient device body (14) having a tip portion (16), a flange (26) and an intermediate side wall portion (22) extending outwardly from the tip portion (16) to the flange (26), wherein the flange (26) is sized and shaped to encompass the female clitoris; wherein, the tip portion (26) is deformable and defines a vacuum producing upper chamber (18a), and the intermediate side wall portion (22) is outwardly convex comprising a plurality of protuberances and is substantially non-deformable, the intermediate side wall portion (22) defines a vacuum reservoir lower chamber (18b), thereby causing vascular engorgement and enhancing sexual satisfaction. The tip portion (16) is at least partially deformable, or compressible in order to produce a partial vacuum within the interior vacuum chamber (18) sufficient to seal the device (10) to the user's body by the differential in air pressure between the air within the vacuum chamber (18) and the atmospheric air pressure.

The above manual operating device as shown in FIG. 1 has been improved into an electrical automate device, for example, referring to FIG. 2, a European Patent No. EP3228297B1 which discloses a pressure waves massage device for the clitoris. The pressure waves massage device comprises a pressure filed generating device which has at least one cavity (12) with a first end (12a) and a second end (12b) located opposite the first end (12a) and distanced from the first end (12a), with the cavity (12) being delimited by a side wall (12c) joining its two ends (12a, 12b) to one another, and the first end (12a) being provided with an opening (8) for placing on the clitoris, and a drive device (20, 22), which is configured to generate a change in volume of the at least one cavity (12) between a minimum volume and a maximum volume such that a stimulating pressure field is generated in the at least one opening (8), wherein the cavity (12) is formed by a single continuous chamber (14), the side wall (12c) of the chamber (14) which delimits the cavity (12) and joins its two ends (12a, 12b) to one another other is free of points of discontinuity, the cavity (12) of the chamber (14) is closed at its second end (12b) by a flexible membrane (18) which extends essentially over the whole cross-section of the cavity (12) and is moved by the drive device (20, 22) alternately in the direction of the at least one opening (8) and in a direction opposite to the latter, and the ratio of the volume change to the minimum volume is not lower than 1/10 and not greater than 1.

Referring to FIG. 3, European Patent No. EP3429537B1 also discloses another massage device (1) for massage by means of pressure waves, which comprises a housing (2) having a grip section (4) and a massage section (6), at least one first chamber (8, 10) having an opening (12) leading towards the outside in the massage section, and a drive means (39) arranged in the housing for changing the volume (V1) of the first chamber (8), wherein the drive means (39) has at least one coil element (32, 34) and at least one magnetic core (38) arranged parallel to the coil element (32, 34) and movably guided parallel to a central axis (A) of the coil element (32, 34) for acting on the first chamber (8), wherein the magnetic core (38) has at least one permanent magnet (44, 46), and wherein a ratio of the mass of the magnetic core (m1) to the mass of the entire massage device (m2) is in a range between 1:6 and 1:250.

Referring to FIG. 4, U.S. Pat. No. 10,857,063 also discloses a stimulation device (1) for erogenous zones, in particular for the clitoris, which comprises a first chamber (3), a second chamber (4) having a flexible wall (41); a drive unit (61) in physical communication with the flexible wall (41) to cause at least a portion of the flexible wall (41) to deflect in opposing directions, thereby resulting in a changing volume of the second chamber (4), the changing volume of the second chamber (4) resulting in modulated positive and negative pressures with respect to an ambient pressure; a flexible material including an opening (51) and configured to sealingly engage a portion of a body of a user including a clitoris (12), the modulated positive and negative pressures to be applied to the portion of the body via the at least one opening (51), the at least one opening (51) being a sole opening of the second chamber (4) to an exterior of the valveless stimulation device (1); a control device (7) configured to receive input from the user and control the drive unit (61) to cause the at least the portion of the flexible wall (41) to deflect to create the modulated positive and negative pressures; and a housing (8) enclosing the drive unit (61) and the control device (7), at least a portion of the flexible material protruding from the housing (8) and at least a portion of the flexible material extending into the housing (8) to form the flexible wall (41), wherein the flexible material protruding from the housing (8) and the flexible material extending into the housing (8) to form the flexible wall (41) are formed in one piece.

It is apparent that the stimulation devices as shown in FIG. 2 to FIG. 4 are improved from the stimulation concept of deformable vacuum chamber to equipped with power source and electrical driving mechanism to create a negative pressure applied to the clitoris. However, the major drawback of such deformable chamber or flexible chamber remains unsolved. That is the conventional devices are configured to produce pressure waves through changing volume of the deformable or flexible chamber, but it is not liable and durable. In order to produce negative pressure at the at least one opening of the deformable or flexible chamber, the chamber must be positioned appropriately, impinges on a part of the user's body and sealed from outside. Once there is air leakage in the sealing mechanism of the deformable or flexible chamber or, if the at least one opening of the deformable or flexible chamber is not pressed against the user's body correctly, the negative pressure fails to create in the deformable or flexible chamber, the device fails to function and performs pressure wave massaging. Since the at least one opening of the deformable or flexible chamber is required to properly press against the predetermined portion of the body surface, preferably in a sealed manner, that requires specific training and skill to accomplish perfectly, or the negative pressure effect would be discounted.

In addition, the chamber of the conventional massage device is preferred to have a funnel shape and widens towards the at least one opening to amplify the pressure waves, so that to deform the chamber wall or membrane is the only way to produce negative pressure and thus itis preferred to use flexible material to configure the chamber wall or membrane. However, flexible material is not as liable and durable as rigid material that reduces the life span of the device. Further since the wall or membrane of the deformable or flexible chamber is flexible, the maximum volume and minimum volume of the chamber is difficult to control and thus the wave pressure produce with respect to the user body is not stable and controllable for best and desired user feeling. Therefore, it is a long felt need in the industry to provide an air wave massage device with rigid air chamber instead of deformable or flexible chamber.

When using a flexible membrane to be displaced in a reciprocal motion by the drive means for alternately generating underpressure and overpressure, the minimum volume of the cavity is defined as the volume when the at least one opening of the cavity is imaginarily closed with a virtual planar surface and the membrane in an operating state or a position with the least distance from the at least one opening. In contrast, the maximum volume of the cavity of the chamber is defined as the volume when the at least one opening of the cavity is imaginarily closed with a virtual planar surface and the membrane is in an operating state or a position with the greatest distance from the at least one opening.

### SUMMARY OF THE PRESENT INVENTION

The invention is advantageous in that it provides a non-contact induction air wave massage device, which produces air pressure wave without flexible chamber in a non-contact induction manner.

Another advantage of the invention is to provide a non-contact induction air wave massage device, wherein the volume changing is accomplished by a pressure valve disposed in a rigid air chamber and being driven to move back and forth repeatedly without contact with the driving mechanism.

Another advantage of the invention is to provide a non-contact induction air wave massage device with good water resistance by eliminating all connecting means in the pressure chamber.

Another advantage of the invention is to provide a non-contact induction air wave massage device, wherein the air wave pressure produced is stable and controllable to meet the user's desired feeling.

Additional advantages and features of the invention will become apparent from the description which follows and may be realized by means of the instrumentalities and combinations particular point out in the appended claims.

According to the present invention, the foregoing and other objects and advantages are attained by a non-contact induction air wave massage device, comprising:
a housing having a housing cavity therein;
a rigid air wave cylinder, being supported in the housing, defining an air wave chamber therein, and having at least one opening communicating the air wave chamber with outside and being configured for sealingly enclosing by a body surface of a user;
a magnetic air pressure valve member comprising a valve member body configured to be slidably disposed in the air wave chamber of the air wave cylinder, and one or more magnetic inducible elements arranged on the valve member body; and
a magnetic driving mechanism arranged outside the air wave cylinder and positioned in the housing cavity of the housing, wherein the magnetic driving mechanism is configured to generate a magnetic force to induce and drive the magnetic air pressure valve member to move back and forth reciprocately along a motion axis in the air wave chamber so as to change the air volume and air pressure between the magnetic air pressure valve member and the at least one opening within the air wave chamber while the at least one opening of the air wave cylinder is enclosed by the body surface of the user.

In one embodiment, the magnetic driving mechanism comprises an electromagnetic coil provided along a radial direction of the air wave chamber and has no contact with the magnetic air pressure valve member.

In one embodiment, the electromagnetic coil is spaced apart from the magnetic air pressure valve member.

In one embodiment, the magnetic driving mechanism comprises one or more magnets provided along a radial direction of the air wave chamber and has no contact with the magnetic air pressure valve member.

In one embodiment, the one or more magnets are spaced apart from the magnetic air pressure valve member.

In one embodiment, the non-contact induction air wave massage device further comprises a control unit configured for controlling the magnetic driving mechanism to generate the magnetic force to induce and drive the magnetic air pressure valve member with no contact therewith, so as to cause the magnetic air pressure valve member to reciprocate within the air wave chamber to generate air waves at the at least one opening of the air wave cylinder.

In one embodiment, the non-contact induction air wave massage device further comprises a power source electrically connected to the control unit.

In one embodiment, wave propagates are generated between the magnetic air pressure valve member and the at least one opening of the air wave cylinder and exit the at least one opening to create a massage effect to the portion of the user's body positioned surrounding by the at least one opening of the air wave cylinder.

In one embodiment, no flexible wall or membrane is required in the present invention, wherein the magnetic air wave valve member is induced by the magnetic driving mechanism to conduct reciprocal motion within the circular rigid air wave cylinder for alternately generating underpressure and overpressure, so that the volume of the air wave chamber of the air wave cylinder can be minimized to produce air waves at the at least one opening of the air wave chamber without the requirement of having the at least one opening strictly pressing against the body surface of the user. Alternatively, when the at least one opening of the air wave cylinder is imaginarily closed with the body surface of the user, the minimum volume of the air wave chamber (while the magnetic air pressure valve member moves forwards) and the air wave pressure is increased to create an overpressure in the air wave chamber, and that, in contrast, the maximum volume of the air wave chamber (while the magnetic air pressure valve member moves backwards) and the air wave pressure is reduced to create an underpressure in the air wave chamber, such that air pressure waves are applied at the at least one opening of the air wave cylinder with respect to the user's body.

In one embodiment, due to an induced magnetic field when the electromagnetic coils are supplied with electric current, the magnetic air pressure valve member is induced to move back and forth correspondingly with the back-and-forth movement of the electromagnetic coil.

In one embodiment, the non-contact driven air wave massage device comprises waterproof barrier walls, wherein the waterproof barrier walls are fixedly connected to the housing or formed by a part of the housing, wherein the air wave chamber is provided on a side of the waterproof barrier walls and the magnetic driving mechanism is provided on another side of the waterproof barrier walls.

In one embodiment, the air wave chamber is at least partially located inside space enclosed by the waterproof barrier walls and the magnetic driving mechanism is provided inside the housing.

In one embodiment, the magnetic driving mechanism comprises at least one electromagnetic coil placed around outer walls of the air wave chamber, and the at least one electromagnetic coil is electrically connected to the control unit.

In one embodiment, the at least one electromagnetic coil is provided on outer walls of the waterproof barrier walls and parallel to inner walls of the air wave cylinder.

In one embodiment, the magnetic driving mechanism comprises at least one magnet and an electric device, an output end of the electric device is connected to the at least one magnet, the at least one magnet is correspondingly provided along the radial direction of the air wave chamber and spaced apart from the magnetic air pressure valve member, and the electric device drives the at least one magnet which drives the magnetic air pressure valve member to move through magnetic forces.

In one embodiment, the magnetic driving mechanism comprises at least one magnet, an electric device, and a connecting piece, an output end of the electric device is connected to the connecting piece, and the at least one magnet is fixed on the connecting piece, wherein the at least one magnet is correspondingly provided and spaced apart from the magnetic air pressure valve member along a radial direction of the air wave chamber, wherein the at least one magnet is coupled with the magnetic air pressure valve member through magnetic attraction, wherein the electric device, through the connecting piece, drives the at least one magnet to make a longitudinal reciprocating motion towards an outer wall of the air wave chamber, causing the at least one magnet, through magnetic forces, to drive the magnetic air pressure valve member to make a longitudinal reciprocating motion within the air wave chamber.

In one embodiment, the magnetic air pressure valve member comprises a permanent magnet, having a N pole and a S pole provided in a radial direction of the air wave chamber, and two magnets respectively provided on the connecting piece and attract the permanent magnet in a direction close to an outer wall of the air wave chamber.

In one embodiment, the connecting piece is cylindrical and movably sleeved on an outer wall of the air wave chamber.

In one embodiment, the air wave cylinder is provided with at least one air hole, and the at least one air hole is communicated with the at least air wave chamber.

In one embodiment, vent gaps or vent slots are provided between outer walls of the air wave cylinder and the waterproof barrier walls, and the vent gaps or the vent slots are communicated with the at least one air hole, and the vent gaps or vent slots are communicated with outer portions of the housing.

In one embodiment, the air wave chamber is substantially cylinder-shaped and space enclosed by the waterproof barrier walls is substantially cylinder-shaped.

In one embodiment, a cross-sectional area of the at least one opening is equal to or less than a cross-sectional area of the air wave chamber.

In one embodiment, a largest portion at a cross section of the magnetic air pressure valve member is circular.

In one embodiment, the air wave chamber is provided with limiting portions at two ends of a moving path of the magnetic air pressure valve member.

In one embodiment, the magnetic air pressure valve member is provided with sealing elements.

The present invention generates air waves through a non-contact driving mode, greatly improves waterproof performance of the device, and expands the application scenario.

Still further objects and advantages will become apparent from consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is schematic view illustrating operation of a first conventional massage device.

FIG. 2 is a sectional view of a second conventional massage device.

FIG. 3 is a sectional view of a third conventional massage device.

FIG. 4 is a sectional view of a fourth conventional massage device.

FIG. 5 is a sectional view of a non-contact induction air wave massage device according to a first preferred embodiment of the present invention.

FIG. 6 is a partial sectional view of a portion A in FIG. 5 of the non-contact induction air wave massage device according to the above first preferred embodiment of the present invention.

FIG. 7 is a sectional view of the non-contact induction air wave massage device according to a first alternative mode of the above first preferred embodiment of the present invention.

FIG. 8 is a sectional view of the non-contact induction air wave massage device according to a second alternative mode of the above first preferred embodiment of the present invention.

FIG. 9 is a sectional view of the non-contact induction air wave massage device according to a third alternative mode of the above first preferred embodiment of the present invention.

FIG. 10 is a sectional view of the non-contact induction air wave massage device according to a fourth alternative mode of the above first preferred embodiment of the present invention.

FIG. 11 is a sectional view of the non-contact induction air wave massage device according to a fifth alternative mode of the above first preferred embodiment of the present invention.

FIG. 12 is a sectional view of the non-contact induction air wave massage device according to a sixth alternative mode of the above first preferred embodiment of the present invention.

FIG. 13 is a sectional view of the non-contact induction air wave massage device according to a seventh alternative mode of the above first preferred embodiment of the present invention.

FIG. 14 is a sectional view of a tubular connecting piece of the non-contact induction air wave massage device according to the above first preferred embodiment of the present invention.

FIG. 15 is an exploded perspective view of a non-contact induction air wave massage device according to a second preferred embodiment of the present invention.

FIG. 16 is a sectional perspective view of the non-contact induction air wave massage device according to the above second preferred embodiment of the present invention.

FIG. 17A is a perspective view of the non-contact induction air wave massage device according to the above second preferred embodiment of the present invention.

FIG. 17B is a partial exploded perspective view of the non-contact induction air wave massage device according to the above second preferred embodiment of the present invention.

FIG. 17C is another partial exploded perspective view of the non-contact induction air wave massage device according to the above second preferred embodiment of the present invention.

FIG. 18A is a sectional view illustrating an alternative mode of the non-contact induction air wave massage device according to the above embodiments of the present invention.

FIG. 18B is a partial enlarged sectional view of the boxed portion in FIG. 18A according to the alternative mode of the non-contact induction air wave massage device of the above embodiments of the present invention.

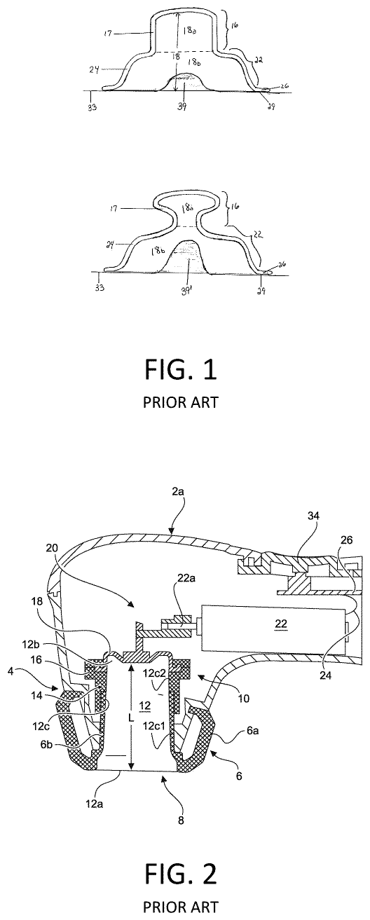

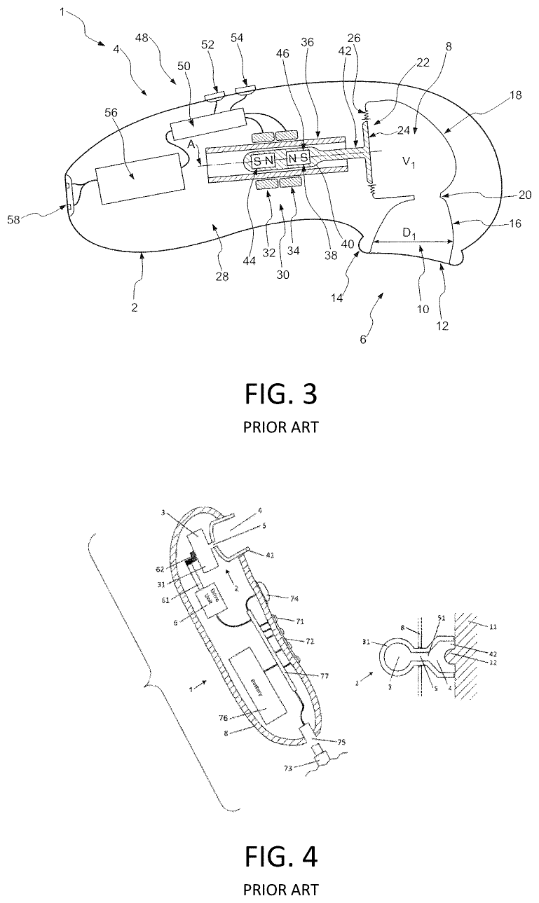

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

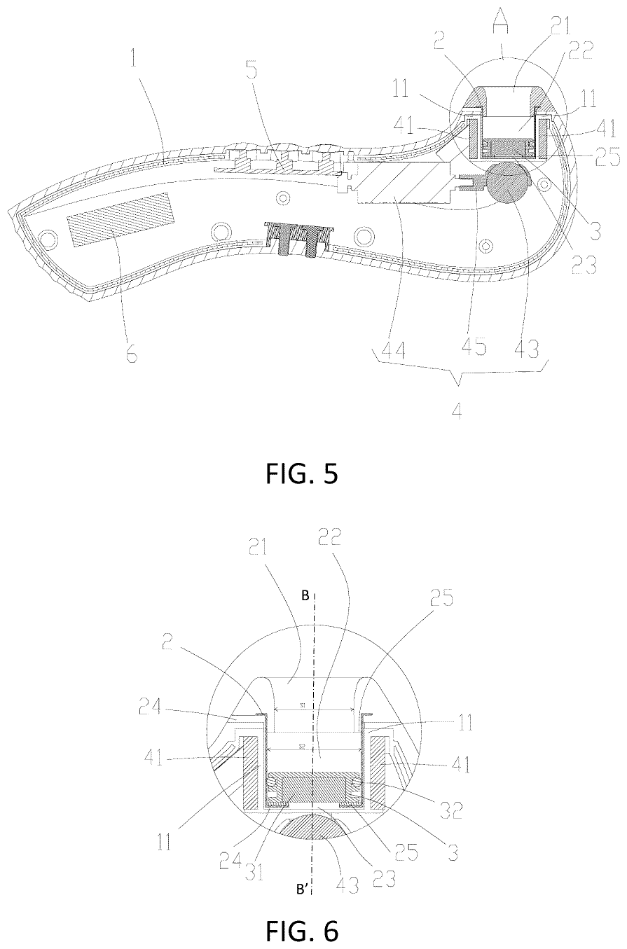

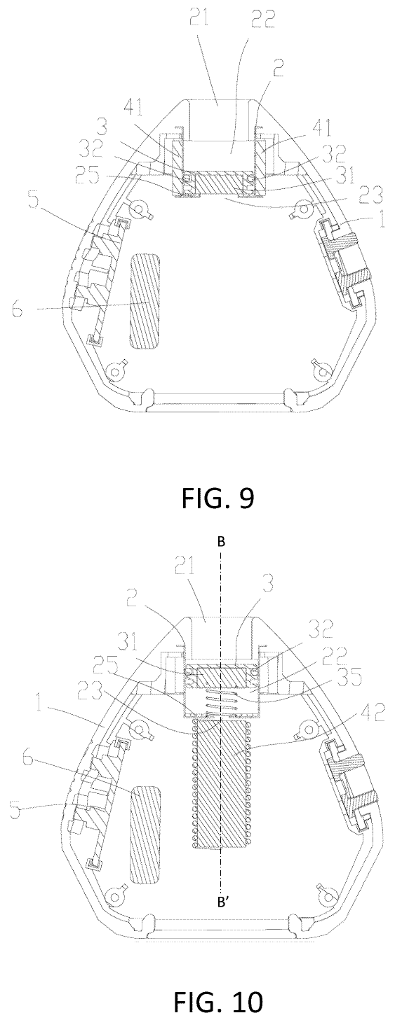

Referring to FIG. 5 to FIG. 10 of the drawings, a non-contact induction air wave massage device is illustrated, which comprises a housing 1, air wave cylinder 2, a magnetic air pressure valve member 3, a magnetic driving mechanism 4, a control unit 5 and a power source 6.

The housing 1 is provided with the air wave cylinder 2. The air wave cylinder 2, which is a cylindrical tubular body made of rigid material, has at least one opening 21 and defines a circular air wave chamber 22 therein.

The magnetic air pressure valve member 3 is substantially sealed and slidingly disposed inside the air wave chamber 22 and comprises at least one magnet or at least one component made of a magnetic attractive substance.

The magnetic driving mechanism 4 is arranged to be located outside the air wave cylinder 2 and fixedly supported in the housing 1. The magnetic driving mechanism 4 comprises at least one electromagnetic coil and/or at least one magnet 41 provided along a radial direction of the air wave chamber 22 and spaced apart from the magnetic air pressure valve member 3. The power source 6 is electrically connected to the control unit 5 and supplies the control unit 5 with electrical power.

The control unit 5 controls the magnetic driving mechanism 4 to apply electromagnetic forces or magnetic forces in a non-contact manner to the magnetic air pressure valve member 3, so as to make the magnetic air pressure valve member 3 reciprocate back and forth along a motion axis B-B′ in the air wave chamber 22 (as shown in FIG. 6). The magnetic air pressure valve member 3 is induced to move back and forth reciprocately to drive air flow to change a volume between the magnetic air pressure valve member 3 and the opening 21 of the air wave cylinder 2, so as to generate air waves at the at least one opening 21.

The non-contact induction air wave massage device further comprises waterproof barrier walls 11, which are fixedly connected to the housing 1 or formed by a part of the housing 1. The air wave cylinder 2 is provided on an inner side of the waterproof barrier walls 11 and the magnetic driving mechanism 4 is provided on an outer side of the waterproof barrier walls 11. The arrangement of waterproof barrier walls 11 greatly improves water resistance of the non-contact induction air wave massage device of the present invention.

The air wave cylinder 2 is at least partially located inside a space enclosed by the waterproof barrier walls 11 and the magnetic driving mechanism 4 is provided inside the housing 1.

As shown in FIG. 6 and FIG. 8, according to the above first preferred embodiment of the present invention, the magnetic driving mechanism 4 comprises at least one electromagnetic coil 41 arranged around an outer wall of the air wave cylinder 2, wherein the at least one electromagnetic coil 41 is electrically connected to the control unit 5. The at least one electromagnetic coil 41 is preferred to be provided on outer walls of the waterproof barrier walls 11 and arranged to be parallel to an inner wall of the air wave cylinder 2. In the present embodiment, the control unit 5 energizes the at least one electromagnetic coil 41 and drives the magnetic air pressure valve member 3 through the at least one electromagnetic coil 41.

According to an alternative mode of the first preferred embodiment, as shown in FIG. 10, the magnetic driving mechanism 4 comprises at least one electromagnet 42 and is electrically connected to the control unit 5. The at least one electromagnet 42 is correspondingly provided and spaced apart from the magnetic air pressure valve member 3 along a longitudinal direction of the air wave chamber 22, such that the at least one electromagnet 42 drives the magnetic air pressure valve member 3 by switching polarity.

In addition, as shown in FIG. 10, a spring 35 is arranged below the magnetic air pressure valve member 3. Correspondingly, the magnetic air pressure valve member 3 comprises a permanent magnet or a magnetic attractable component (such as an iron block) 31 arranged along the motion axis B-B′ with the electromagnetic 42 and the spring 35, such that the magnetic air pressure valve member 3 is capable of being driven by start and release of the electromagnet 42.

Referring to FIG. 5, according to the first preferred embodiment of the present invention, the magnetic driving mechanism 4 comprises at least one magnet 43, an electric device 44, and a connecting piece 45, wherein an output end of the electric device 44 is connected to the connecting piece 45 and the at least one magnet 43 is fixed on the connecting piece 45. The at least one magnet 43 is correspondingly provided and spaced apart from the magnetic air pressure valve member 3 along a longitudinal direction, i.e. along the motion axis B-B′, of the air wave chamber 22. The electric device 44 is configured to drive an angle of the at least one magnet 43 to change through the connecting piece 45, so that an N pole and an S pole of the at least one magnet 43 alternately correspond to the magnetic air pressure valve member 3. When polarities of the permanent magnet 31 of the magnetic air pressure valve member 3 and an opposite end thereof remains unchanged, the at least one magnet 43 alternately corresponds to the N pole and the S pole, and magnetic forces are utilized to drive the magnetic air pressure valve member 3 to reciprocate longitudinally in the air wave chamber 22.

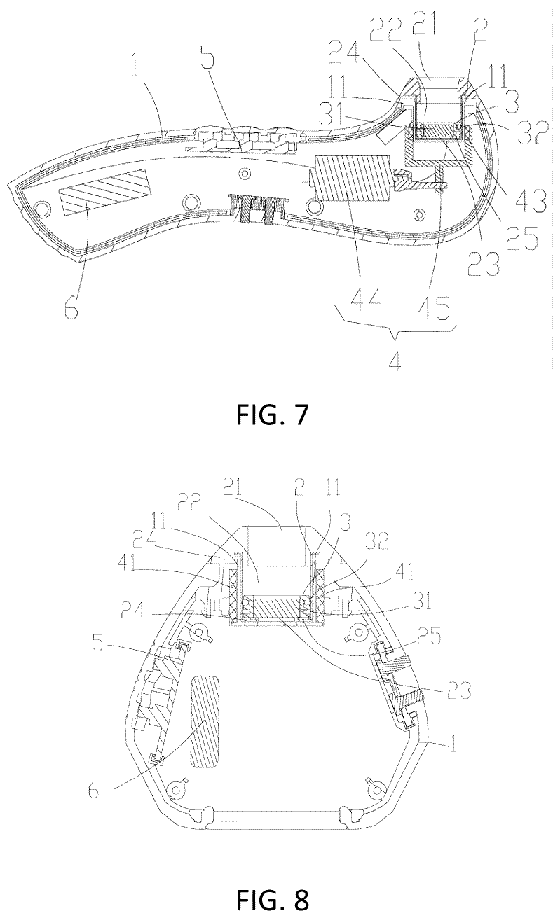

Referring to FIG. 7, according to an alternative mode of the first preferred embodiment of the present invention, the magnetic driving mechanism 4 comprises at least one magnet 43 and an electric device 44, wherein an output end of the electric device 44 is connected to the at least one magnet 43, the at least one magnet 43 is correspondingly provided and spaced apart from the magnetic air pressure valve member 3 along a radial direction of the air wave chamber 22 in such a manner that the electric device 44 is configured to drive the at least one magnet 43 to drive the magnetic air pressure valve member 3 to move through magnetic forces.

Referring to FIG. 7, in particular, the magnetic driving mechanism 4 comprises the at least one magnet 43, the electric device 44, and a connecting piece 45. An output end of the electric device 44 is connected to the connecting piece 45, the at least one magnet 43 is fixed on the connecting piece 45 in such a manner that the at least one magnet 43 is correspondingly provided on and spaced apart from the magnetic air pressure valve member 3 along the radial direction of the air wave chamber 22. The at least one magnet 43 is connected to the magnetic air pressure valve member 3 in a non-contact manner through magnetic attraction. The electric device 44, through the connecting piece 45, is configured to drive the at least one magnet 43 to reciprocate longitudinally towards the outer wall of the air wave cylinder 2, causing the at least one magnet 43 to drive the magnetic air pressure valve member 3 through magnetic forces to reciprocate longitudinally within the air wave chamber 22.

Referring to FIG. 7 and FIG. 12, according to an alternative mode of the above first preferred embodiment, the magnetic air pressure valve member 3 comprises a permanent magnet 31, wherein N and S poles of the permanent magnet 31 are provided in a radial direction of the air wave chamber 22. Two magnets 43 are respectively provided on the connecting piece 45 and attract the permanent magnet 31 in a direction close to the outer wall of the air wave cylinder 2.

As shown in FIG. 14, the connecting piece 45 is cylindrical and movably sleeved on the outer wall of the air wave cylinder 2 and two magnets 43 are received and affixed in two opposing magnet slots 451 formed in an inner wall surface of the connecting piece 45 to induce the permanent magnet 31 coaxially provided in the magnetic air pressure valve member 3 correspondingly so as to drive the magnetic air pressure valve member 3 to move in the air wave chamber 22 back and forth reciprocately.

As shown in FIG. 7, the air wave cylinder 2 is provided with at least one air hole 23 which is communicated with the air wave chamber 22 and provided to reduce running resistance of the magnetic air pressure valve member 3.

As shown in FIG. 6 and FIG. 8, according to the first preferred embodiment of the present invention, vent gaps or vent slots 24 are provided between the outer wall of the air wave cylinder 2 and the waterproof barrier walls 11, wherein the vent gaps or the vent slots 24 are communicated with the at least one air hole 23, and the vent gaps or vent slots 24 are communicated with outer portions of the housing 1.

As shown in FIG. 12, according to an alternative mode of the above first preferred embodiment of the present invention, the magnetic driving mechanism 4 comprises a driving power device 40, which is embodied as a linear motor, including a stator 46 and an actuator 47, wherein one end of the connecting piece 45 is fixed on the actuator 47 and the at least one magnet 43 is driven by the linear motor 40 near the outer wall of the air wave cylinder 2 to reciprocate longitudinally.

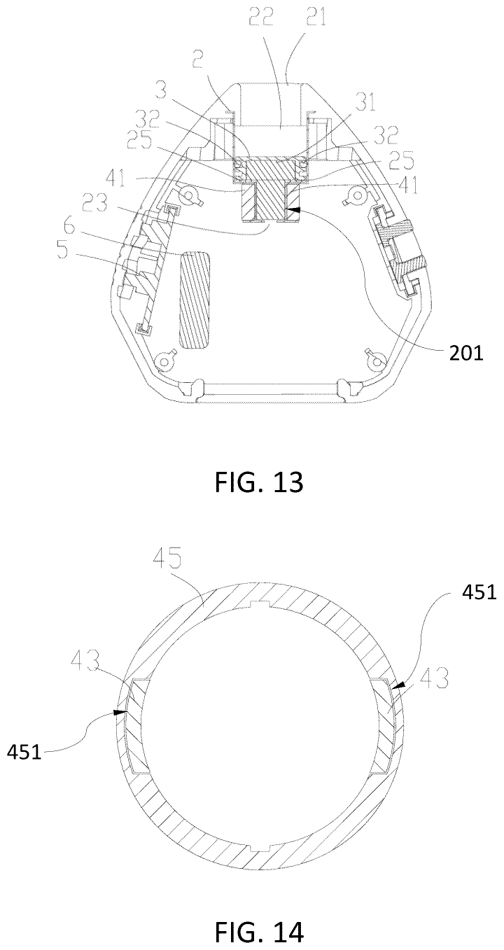

As shown in FIG. 13, according to an alternative mode of the above first preferred embodiment of the present invention, the permanent magnet 31 of the magnetic air pressure valve member 3 is T-shaped, wherein a bottom portion of the air wave cylinder 2 is downwardly extended to form a through slot portion 201 for a bottom portion of the permanent magnet 31 to be inserted therein, so as to couple with the at least one electromagnetic coil 41 arranged around an outer wall of the through slot portion 201 I such a manner that the at least one electromagnetic coil 41 is capable of driving the T-shaped permanent magnet 31 to reciprocate back and forth in the air wave chamber 22.

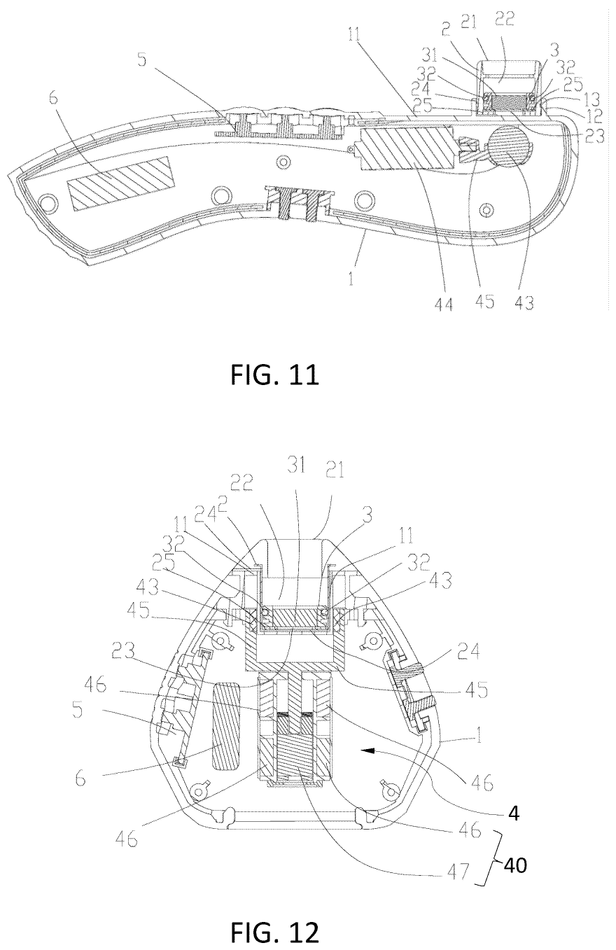

The air wave cylinder 2 can also be arranged on an outer surface of the housing 1. As shown in FIG. 11, according to an alternative mode of the above first preferred embodiment of the present invention, a slot 12 is provided on the housing 1 and the air wave cylinder 2 is placed and mounted on the slot 12. In particular, the air wave cylinder 2 is secured by latching protrusions 13, so that it is difficult for the air wave cylinder 2 to fall off. The magnetic driving mechanism 4 is installed in the housing 1. This alternative mode allows easy replacement of the air wave cylinder 2, making massage more hygienic.

According to the first preferred embodiment, the air wave cylinder 2 is preferred to be configured in substantial cylinder-shape, and the air wave chamber 22 is a space enclosed by the waterproof barrier walls 11 in substantial cylinder-shape too.

As shown in FIG. 6, it is appreciated that a cross-sectional area S1 of the at least one opening 21 is preferred to be equal to or less than a cross-sectional area S2 of the air wave chamber 22. Also, the magnetic air pressure valve member 3 has a circular cross section having the largest diameter equal to the cross-sectional area S2 of the air wave chamber 22 so as to be slidably and sealedly disposed in the air wave chamber 22. Parallel lines of inner walls of the air wave cylinder 2 are perpendicular to a radial section of the air wave cylinder 2.

As shown in FIG. 7, according to an alternative mode of the above first preferred embodiment, the air wave cylinder 2 is provided with two limiting elements 25 at two ends thereof respectively to define a movement path for the magnetic air pressure valve member 3 within the air wave chamber 22, wherein the limiting elements 25 are made of soft materials.

According to the above first preferred embodiment, the magnetic air pressure valve member 3 is provided with at least one sealing element 32, which has an outer diameter slightly larger than a diameter of said air wave chamber, mounted therearound to provide a sealing effect between the magnetic air pressure valve member 3 and the air wave cylinder 2, so that back and forth linear movements of the magnetic air pressure valve member 3 push air to form concentrated air flows in the air wave chamber 22 reciprocately to produce air waves at the opening 21.

The power source 6 can be a battery or an access port of an external power source.

According to the above first preferred embodiment of the present invention, the non-contact induction air wave massage device generates air waves in a non-contact driving manner, which greatly improves waterproof performance of the device and expands the use scenarios.

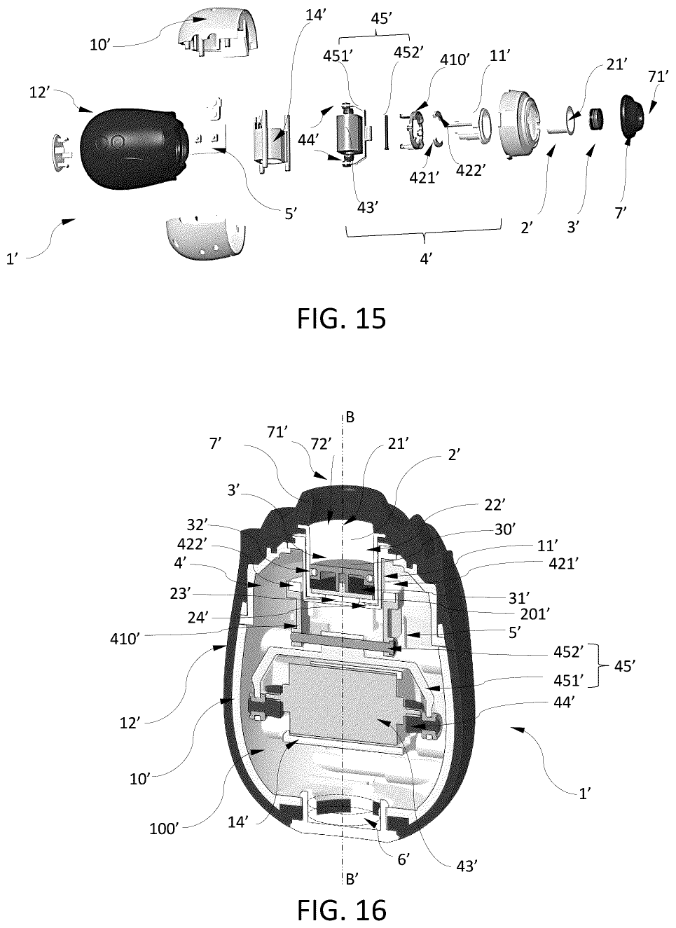

Referring to FIG. 15 to FIG. 16, a non-contact induction air wave massage device according to a second preferred embodiment of the present invention is illustrated, which comprises a housing 1′, a rigid air wave cylinder 2′, a magnetic air pressure valve member 3′, and a magnetic driving mechanism 4′.

The housing 1′ has a shell 10′, made of rigid material such as plastic or metal, having a housing cavity 100′ defined therein, a sleeve 12′, preferably made of silicon, covering the shell 10′.

The non-contact induction air wave massage device further comprises a suction nozzle 7′ being provided at an operation end of the shell 10′ and defining a suction opening 71′ communicating the housing cavity 100′ with outside.

The rigid air wave cylinder 2′, which is made of non-magnetic rigid material, such as plastic or ceramic, that is not magnetic attractable but allowing magnetic fields penetrating through, and supported in the housing 1′, defines an air wave chamber 22′ therein and has a at least one opening 21′ at one end thereof communicating the air wave chamber 22′ with outside and being configured for sealingly enclosing by a body surface of a user.

Preferably, the suction nozzle 7′, made of soft material such as silicon, has a cavity opening 72′ at a bottom end thereof, wherein the cavity opening 72′ has a diameter larger than the suction opening 71′ provided at a top end of the suction nozzle 7′ equal to the at least one opening 21′. The air wave cylinder 2′ further has a bottom 201′ and is supported right below the suction nozzle 7′ coaxially in such a manner that the at least one opening 21′, having a diameter slightly smaller than the cavity opening 72′, is aligned coaxially with cavity opening 72′ of the suction nozzle 7′ and a bottom wall of the suction nozzle 7′ forms a limiting element to limit a forward movement of the magnetic air pressure valve member 3′ slidably disposed in the air wave chamber 22′, so that while the suction opening 71′ of the suction nozzle 7′ is placed against the body surface of the user, the suction opening 71′ of the suction nozzle 7′ is covered by the user's body surface and the at least one opening 21′ of the air wave cylinder 2′ is enclosed too, such that air wave chamber 22′ becomes an enclosed chamber.

The magnetic air pressure valve member 3′ comprises a valve member body 31′ configured to be slidably disposed in the air wave chamber 22′ of the air wave cylinder 2′, and one or more magnetic inducible elements 30′ arranged on the valve member body 31′.

According to the second preferred embodiment, the valve member body 30′ is a circular body having a predetermined thickness shorter than a depth of the air wave chamber 22′ and a diameter preferably equal to or slightly smaller than a diameter of the air wave chamber 22′, such that the magnetic air pressure valve member 3′ is movable back and forth with respect to an inner wall of the air wave cylinder 2′ in an air-tight manner along a motion axis B-B′ of the air wave chamber 22′. The one or more magnetic inducible elements 31′, which is made of magnetic attractive material such as iron or permanent magnet and has a ring shape, is mounted in the valve member body 30′ coaxially. Further, the valve member body 31′ has at least one ring slot 311′ formed along a periphery side thereof to receive at least one sealing element 32′, which has an outer diameter slightly larger than a diameter of said air wave chamber, such that when the magnetic air pressure valve member 3′ is moving along the motion axis B-B′ of the air wave chamber 22′, the sealing element 32′ ensures a sealing effect between an inner wall of the air wave cylinder 2′ and the magnetic air pressure valve member 3′. By means of the air wave cylinder 2′, the magnetic air pressure valve member 3′ is isolated from the housing cavity 100′ of the housing 1′ and the magnetic air pressure valve member 3′ is driven to move back and forth between the bottom 201′ and the at least one opening 21′ of the air wave cylinder 2 within the air wave chamber 22′ through a magnetic induction generated by the magnetic driving mechanism 4′.

Preferably, when the valve member body 31′ and the air wave cylinder 2′ are in circular shape, the sealing element 32′ is in ring shape having an outer diameter larger than the diameter of the air wave cylinder 2′ for 0.4 mm or less. In other words, the overall diameter of the magnetic air pressure valve member 3′, i.e. the outer diameter of the at least one sealing element 32′ mounted around the valve member body 31′, is larger than the diameter of the air wave cylinder 2′ for 0.4 mm or less.

It is worth mentioning that when the valve member body 31′ is made of rigid material, its outer diameter is preferred to be slightly smaller than the diameter of the air wave cylinder 2′ for 0.02 mm or less.

Alternatively, when the sealing element 32′ is in V shape or Y shape, the overall diameter of diameter of the magnetic air pressure valve member 3′, i.e. after the at least one sealing element 32′ is mounted around the valve member body 31′, is larger than the diameter of the air wave cylinder 2′ for 1 mm to 2 mm.

In other words, the magnetic driving mechanism 4′ is arranged outside the air wave cylinder 2′ and positioned in the housing cavity 100′ of the housing 1′, wherein the magnetic driving mechanism 4′ is configured to generate a magnetic force to induce and drive the magnetic air pressure valve member 3′ to move back and forth reciprocately along the motion axis B-B′ in the air wave chamber 22′ so as to change an air volume and air pressure between the magnetic air pressure valve member 3′ and the at least one opening 21′ within the air wave chamber 22′ while the at least one opening 21′ of the air wave cylinder 2′ is enclosed by the body surface of the user.

According to the second preferred embodiment, the magnetic driving mechanism 4′ comprises a driver member 410′, a pair of arc-shaped driving magnets 421′, 432′ mounted on the driver member 410′, a motor 43′ mounted by a motor support 14′ provided in the housing 1′, at least one eccentric driving element 44′ arranged to be driven by the motor 43′ to rotate eccentrically about an axis of the motor 43′, a connection link 45′ connecting between the at least one eccentric driving element 44′ and the driver member 41. The driver member 410′ is arranged coaxially around the air wave cylinder 2′, such that the pair of driving magnets 421′, 422′ are symmetrically positioned opposingly with the at least one magnetic inducible element 31′ such that forward and backward (up and down as shown in FIG. 16) movements of the driving magnets 421′, 422′ substantially induce the at least one magnetic inducible element 31′ to move correspondingly so as to drive the magnetic air pressure valve member 3′ moving back and forth in the air wave chamber 22′ along the motion axis B-B′ accordingly.

According to the second preferred embodiment, the permanent magnet 31′ of the magnetic air pressure valve member 3′ has a N pole and a S pole provided in a radial direction of the air wave chamber 22′, and the two driving magnets 421′, 422′ are respectively provided in such a manner to oppose and attract the permanent magnet 31′ in a direction close to an outer wall of the air wave cylinder 2′.

According to the second preferred embodiment, a pair of eccentric driving elements 44′ are connected to two ends of the motor 43′ to drive two ends of a C-shape connector 451′ of the connection link 45′, which are rotatably coupled with the pair of eccentric driving elements 44′ respectively, to drive a connecting axle 452′ of the connection link 45′ to move back and forth along the motion axis B-B′ and thus driving the driver member 410′ to move correspondingly along the motion axis B-B′.

According to the second preferred embodiment, the non-contact induction air wave massage device further comprises a control unit 5′ and a power source 6′. The control unit 5′ is configured for controlling the magnetic driving mechanism 4′ to generate the magnetic force to induce and drive the magnetic air pressure valve member 3′ with no contact therewith, so as to cause the magnetic air pressure valve member to reciprocate within the air wave chamber 22′ to generate air waves at the at least one opening 21′ of the air wave cylinder 2′. The power source 6′ is a rechargeable battery electrically connected to the control unit 5′ and the motor 43′ to supply electrical power.

It is worth mentioning that the motor-magnet type magnetic driving mechanism 4′ as shown in FIG. 15 and FIG. 16 according to the second preferred embodiment can also be replaced by an electromagnetic coil 41, as embodied in the above first preferred embodiment as shown in FIGS. 6, 8 and 13, provided along a radial direction of the air wave chamber 22′ and has no contact with the magnetic air pressure valve member 3′. In other words, the electromagnetic coil 41 can be arranged around the driver member 410′ while being spaced apart from the magnetic air pressure valve member 3′ through the air wave cylinder 2′, and electrically connected to the control unit 5′ and the power source 8′ so as to generate an electromagnetic field to induce the at least one permanent magnet 31′ to drive the magnetic air pressure valve member 3′ to move back and forth in the air wave chamber 22′. Due to an induced magnetic field when the electromagnetic coils 41 are supplied with electric current, the magnetic air pressure valve member 3, 3′ is induced to move back and forth correspondingly with the back-and-forth movement of the electromagnetic coil 41.

It is worth mentioning that the pair of driving magnets 421′, 422′ of the magnetic driving mechanism 4′ are provided along a radial direction of the air wave chamber 22′ and has no contact with the magnetic air pressure valve member 3′.

Like the above first preferred embodiment, the non-contact driven air wave massage device according to the second preferred embodiment also comprises a waterproof barrier shell 11′, which is constructed by one or more waterproof barrier walls 11′ made of non-magnetic material, surrounding the air wave cylinder 2′, wherein the waterproof barrier shell 11′ are fixedly connected to the housing 10′ or formed by a part of the housing 10′, wherein the air wave cylinder 2′ is provided inside the waterproof barrier shell 11′ and the magnetic driving mechanism 4′ is provided outside the waterproof barrier shell 11′.

In other words, the air wave chamber 22′ is at least partially located inside space enclosed by the waterproof barrier shell 11′ and the magnetic driving mechanism 4′ is provided inside the housing 1′.

When the electromagnetic coil 41 is embodied, the electromagnetic coil 41 is provided on outer walls of the waterproof barrier shell 11′ and parallel to inner walls of the air wave cylinder 2′.

In addition, the air wave cylinder 2′ according to the second preferred embodiment is also provided with at least one air hole 23′, and the at least one air hole 20′ is communicated with the air wave chamber 23′. Further, vent gaps or vent slots 24′ are provided between outer walls of the air wave cylinder 2′ and the waterproof barrier shell 11′, and the vent gaps or the vent slots 24′ are communicated with the at least one air hole 23′, and the vent gaps or vent slots 24′ are communicated with outer portions of the housing 1′.

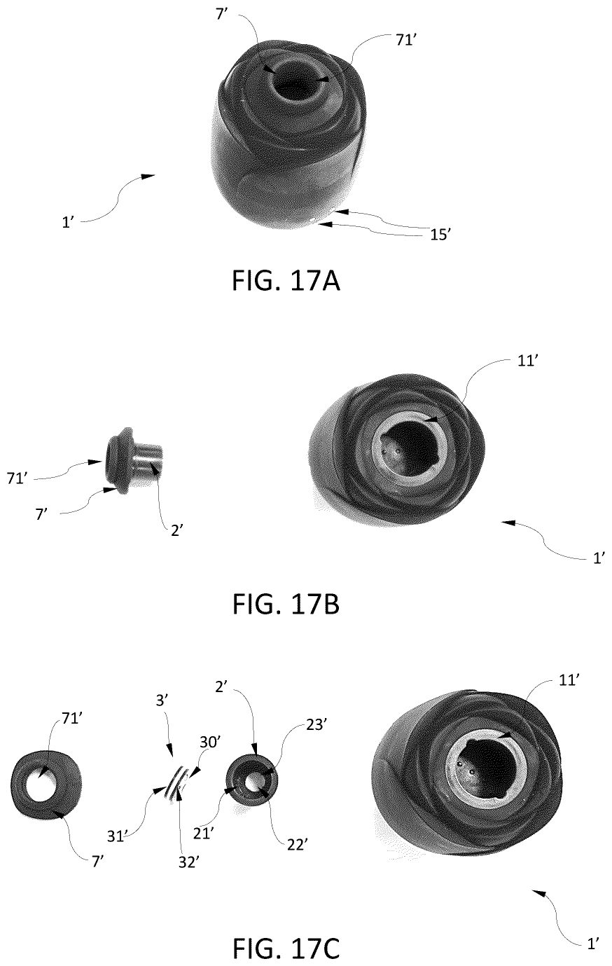

Referring to FIG. 17A to FIG. 17C, the housing 1′ and the barrier shell 11′ sealedly connected to form a waterproof body such that the user may detach the air wave cylinder 2′ and the magnetic air pressure valve member 3′ therein from the barrier shell 11′ for cleaning and maintenance purposes, including to replace the suction nozzle 7′, the permanent magnet 31′ and the sealing element 32′. The suction nozzle 7′ not only configured to lock the air wave cylinder 2′ inside the barrier shell 11′ but also provides nozzle effect for the air waves produced at the opening 21′.

In view of above, wave propagates are generated between the magnetic air pressure valve member 3, 3′ and the at least one opening 21, 21′ of the air wave cylinder 2, 2′ and exit the at least one opening 21, 21′ to create a massage effect to the portion of the user's body positioned surrounding by the at least one opening 21, 21′ of the air wave cylinder 2, 2′.

According to the first and second preferred embodiment of the present invention, no flexible wall or membrane is required, wherein the magnetic air wave valve member 3, 3′ is induced by the magnetic driving mechanism 4, 4′ to conduct reciprocate motion within the circular rigid air wave cylinder for alternately generating underpressure and overpressure, so that the volume of the air wave chamber 22, 22′ of the air wave cylinder 2, 2′ can be minimized to produce air waves at the at least one opening 21, 21′ of the air wave chamber 22, 22′ without the requirement of having the at least one opening 21, 21′ strictly closing by the body surface of the user. Alternatively, when the at least one opening 21, 21′ of the air wave cylinder 2, 2′ is imaginarily closed with the body surface of the user, the minimum volume of the air wave chamber 22, 22′ (while the magnetic air pressure valve member 2, 2′ moves forwards) and the air wave pressure is increased to create an overpressure in the air wave chamber 22, 22′, and that, in contrast, the maximum volume of the air wave chamber 22, 22′ (while the magnetic air pressure valve member 2, 2′ moves backwards) and the air wave pressure is reduced to create an underpressure in the air wave chamber 22, 22′, such that air pressure waves are applied at the at least one opening 21, 21′ of the air wave cylinder 2, 2′ with respect to the user's body.

By inducing the magnetic air pressure valve member 3. 3′ to move back and forth reciprocately in the rigid air wave cylinder 2, 2′ through the magnetic driving mechanism 4, 4′, the air waves produced at the opening 21, 21′ of the rigid air wave cylinder 2, 2′ is a liable and durable arrangement that significantly solves the drawbacks of the deformable or flexible chamber of the conventional massage device. In addition, the rigid air wave cylinder 2, 2′ and the suction nozzle 7′ can be detached from the housing 1′ to be washed and perform maintenance while the conventional massage device is not designed for washing that significantly causes hygiene issues after continuous usage.

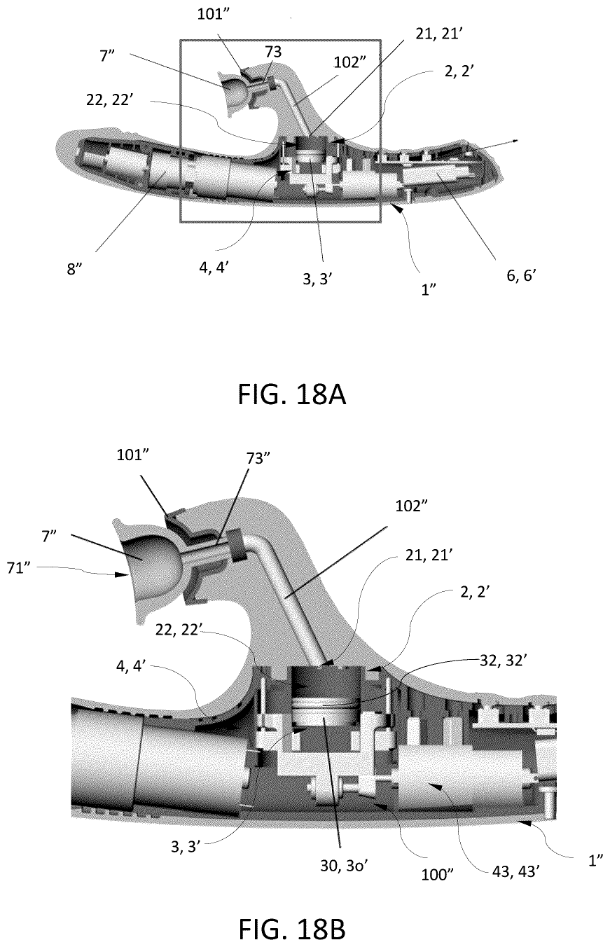

Referring to FIG. 18A and FIG. 18B, an alternative mode of the non-contact induction air wave massage device according to the above embodiments of the present invention, wherein the non-contact induction air wave massage device also comprises a housing 1″ to install the rigid air wave cylinder 2, 2″, the magnetic air pressure valve member 3, 3′ and the magnetic driving mechanism 4, 4′ as disclosed in the above embodiments as illustrated in FIG. 5 to FIG. 17C.

As shown in FIG. 18A and FIG. 18C, the differences between this alternative mode and the above embodiments includes an additional massage apparatus 8″ is also installed in the housing 1″ and the suction nozzle 7′ is not provided adjacent to the at least one opening 21, 21′ of the air wave cylinder 2, 2′ but is provided at an air wave operation end 101″ of the housing 1″. In addition, the at least one opening 21, 21′ is provided in a ceiling wall of the air wave cylinder 2, 2′ and smaller than the diameter of the air wave chamber 22, 22′, wherein an air passage 102″ is provided in the housing 1″ to connect and communicate the at least one opening 21, 21′ with an air inlet tube 73″ of the suction nozzle 7″. Similarly, when the suction opening 71″ of the suction nozzle 7″ is placed against the body surface of the user, the suction opening 71″ of the suction nozzle 7″ is covered by the user's body surface and the at least one opening 21″ of the air wave cylinder 2″ is enclosed too, such that the air wave chamber 22″ becomes an enclosed chamber.

Accordingly, the magnetic driving mechanism 4″ is arranged outside the air wave cylinder 2, 2′ and positioned in the housing cavity 100″ of the housing 1″, wherein the magnetic driving mechanism 4, 4′ is configured to generate a magnetic force to induce and drive the magnetic air pressure valve member 3, 3′ to move back and forth reciprocately along the motion axis in the air wave chamber 22, 22′ so as to change an air volume and air pressure between the magnetic air pressure valve member 3, 3′ and the at least one opening 21, 21′ within the air wave chamber 22, 22′ while the at least one opening 21, 21′ of the air wave cylinder 2, 2′ is enclosed by the body surface of the user.

It is worth to further mention that the magnetic air pressure valve member 3, 3′ of the present invention can also be embodied to be made by a magnetizable material which two opposing sides of the magnetic air pressure valve member 3, 3′ can be magnetized to North and South poles respectively or the top and bottom sides of the magnetic air pressure valve member 3, 3′ can be magnetized to North and South poles respectively to produce a magnetic valve member body 31, 31′ which is magnetically induced by the magnetic driving mechanism 4, 4′ directly without arranging any magnetic inducible element 32, 32′.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A non-contact induction air wave massage device, comprising:
a housing having a housing cavity therein;
an air wave cylinder, made of non-magnetic rigid material and supported in said housing, defining an air wave chamber therein and having at least one opening for communicating said air wave chamber with outside;
a magnetic air pressure valve member disposed in said air wave chamber and configured to be inducible by a magnetic field to slidably move back and forth reciprocately along a motion axis in said air wave chamber; and
a magnetic driving mechanism arranged outside said air wave cylinder and positioned in said housing cavity of said housing, wherein said magnetic driving mechanism is configured to magnetically induce and drive said magnetic air pressure valve member to move back and forth reciprocately along said motion axis in said air wave chamber so as to change an air volume and an air pressure between said magnetic air pressure valve member and said at least one opening within said air wave chamber while said at least one opening of said air wave cylinder is enclosed by a body surface of a user.

2. The non-contact induction air wave massage device, as recited in claim 1, wherein said magnetic air pressure valve member comprises at least one magnetic inducible element configured to be magnetically induced by said magnetic driving mechanism.

3. The non-contact induction air wave massage device, as recited in claim 2, wherein said magnetic air pressure valve member further comprises a valve member body slidably disposed in said air wave chamber of said air wave cylinder, and said at least one magnetic inducible element is arranged on said valve member body.

4. The non-contact induction air wave massage device, as recited in claim 3, wherein said magnetic air pressure valve member further comprises at least one sealing element having an outer diameter slightly larger than a diameter of said air wave chamber, wherein said valve member body is a circular body having a predetermined thickness shorter than a depth of said air wave chamber and said at least one sealing element is mounted around said valve member body to provide a sealing effect between said magnetic air pressure valve member and an inner wall of said air wave cylinder.

5. The non-contact induction air wave massage device, as recited in claim 1, further comprising a waterproof barrier shell, which is constructed by one or more water barrier walls, surrounding said air wave cylinder, such that said air wave cylinder is provided inside said waterproof barrier shell and said magnetic driving mechanism is provided outside said water barrier shell.

6. The non-contact induction air wave massage device, as recited in claim 4, further comprising a waterproof barrier shell, which is constructed by one or more water barrier walls, surrounding said air wave cylinder, such that said air wave cylinder is provided inside said waterproof barrier shell and said magnetic driving mechanism is provided outside said water barrier shell.

7. The non-contact induction air wave massage device, as recited in claim 2, wherein said at least one magnetic inducible element is a ring shape permanent magnet mounted in said valve member body coaxially.

8. The non-contact induction air wave massage device, as recited in claim 6, wherein said at least one magnetic inducible element is a ring shape permanent magnet mounted in said valve member body coaxially.

9. The non-contact induction air wave massage device, as recited in claim 1, wherein said air wave cylinder is provided with at least one air hole communicated with said air wave chamber.

10. The non-contact induction air wave massage device, as recited in claim 6, wherein said air wave cylinder is provided with at least one air hole communicated with said air wave chamber.

11. The non-contact induction air wave massage device, as recited in claim 1, further comprising a suction nozzle having a cavity opening at a bottom end thereof, wherein said cavity opening has a diameter larger than said suction opening provided at a top end of said suction nozzle equal to said at least one opening of said air wave cylinder, wherein said air wave cylinder further has a bottom and is supported right below said suction nozzle coaxially in such a manner that said at least one opening, having a diameter slightly smaller than said cavity opening, is aligned coaxially with said cavity opening of said suction nozzle and a bottom wall of said suction nozzle forms a limiting element to limit a forward movement of said magnetic air pressure valve member slidably disposed in said air wave chamber.

12. The non-contact induction air wave massage device, as recited in claim 2, further comprising a suction nozzle having a cavity opening at a bottom end thereof, wherein said cavity opening has a diameter larger than said suction opening provided at a top end of said suction nozzle equal to said at least one opening of said air wave cylinder, wherein said air wave cylinder further has a bottom and is supported right below said suction nozzle coaxially in such a manner that said at least one opening, having a diameter slightly smaller than said cavity opening, is aligned coaxially with said cavity opening of said suction nozzle and a bottom wall of said suction nozzle forms a limiting element to limit a forward movement of said magnetic air pressure valve member slidably disposed in said air wave chamber.

13. The non-contact induction air wave massage device, as recited in claim 5, further comprising a suction nozzle having a cavity opening at a bottom end thereof, wherein said cavity opening has a diameter larger than said suction opening provided at a top end of said suction nozzle equal to said at least one opening of said air wave cylinder, wherein said air wave cylinder further has a bottom and is supported right below said suction nozzle coaxially in such a manner that said at least one opening, having a diameter slightly smaller than said cavity opening, is aligned coaxially with said cavity opening of said suction nozzle and a bottom wall of said suction nozzle forms a limiting element to limit a forward movement of said magnetic air pressure valve member slidably disposed in said air wave chamber.

14. The non-contact induction air wave massage device, as recited in claim 8, further comprising a suction nozzle having a cavity opening at a bottom end thereof, wherein said cavity opening has a diameter larger than said suction opening provided at a top end of said suction nozzle equal to said at least one opening of said air wave cylinder, wherein said air wave cylinder further has a bottom and is supported right below said suction nozzle coaxially in such a manner that said at least one opening, having a diameter slightly smaller than said cavity opening, is aligned coaxially with said cavity opening of said suction nozzle and a bottom wall of said suction nozzle forms a limiting element to limit a forward movement of said magnetic air pressure valve member slidably disposed in said air wave chamber.

15. The non-contact induction air wave massage device, as recited in claim 1, wherein said magnetic driving mechanism comprises a driver member, a pair of arc-shaped driving magnets mounted on said driver member, a motor mounted by a motor support provided in said housing, at least one eccentric driving element arranged to be driven by said motor to rotate eccentrically about an axis of said motor, a connection link connecting between said at least one eccentric driving element and said driver member, wherein said driver member is arranged coaxially around said air wave cylinder in such a manner that said pair of driving magnets are symmetrically positioned opposingly with said at least one magnetic inducible element such that forward and backward movements of said driving magnets substantially induce said at least one magnetic inducible element to move correspondingly so as to drive the said air pressure valve member moving back and forth in said air wave chamber along said motion axis accordingly.

16. The non-contact induction air wave massage device, as recited in claim 8, wherein said magnetic driving mechanism comprises a driver member, a pair of arc-shaped driving magnets mounted on said driver member, a motor mounted by a motor support provided in said housing, at least one eccentric driving element arranged to be driven by said motor to rotate eccentrically about an axis of said motor, a connection link connecting between said at least one eccentric driving element and said driver member, wherein said driver member is arranged coaxially around said air wave cylinder in such a manner that said pair of driving magnets are symmetrically positioned opposingly with said permanent magnet such that forward and backward movements of said driving magnets substantially induce said permanent magnet to move correspondingly so as to drive the said air pressure valve member moving back and forth in said air wave chamber along said motion axis accordingly.

17. The non-contact induction air wave massage device, as recited in claim 16, wherein said permanent magnet of said magnetic air pressure valve member has a N pole and a S pole provided in a radial direction of said air wave chamber, and said two driving magnets are respectively provided in such a manner to oppose and attract said permanent magnet in a direction close to an outer wall of said air wave cylinder.

18. The non-contact induction air wave massage device, as recited in claim 15, further comprising a control unit and a power source, wherein said control unit is configured for controlling said magnetic driving mechanism to generate said magnetic force to induce and drive said magnetic air pressure valve member with no contact therewith, so as to cause said magnetic air pressure valve member to reciprocate within said air wave chamber to generate air waves at said at least one opening of said air wave cylinder, wherein said power source is electrically connected to said control unit and said motor to supply electrical power.

19. The non-contact induction air wave massage device, as recited in claim 16, further comprising a control unit and a power source, wherein said control unit is configured for controlling said magnetic driving mechanism to generate said magnetic force to induce and drive said magnetic air pressure valve member with no contact therewith, so as to cause said magnetic air pressure valve member to reciprocate within said air wave chamber to generate air waves at said at least one opening of said air wave cylinder, wherein said power source is electrically connected to said control unit and said motor to supply electrical power.

20. The non-contact induction air wave massage device, as recited in claim 17, further comprising a control unit and a power source, wherein said control unit is configured for controlling said magnetic driving mechanism to generate said magnetic force to induce and drive said magnetic air pressure valve member with no contact therewith, so as to cause said magnetic air pressure valve member to reciprocate within said air wave chamber to generate air waves at said at least one opening of said air wave cylinder, wherein said power source is electrically connected to said control unit and said motor to supply electrical power.
